(19) United States
(12) Patent Application Publication
(10) Pub. No.: US 2025/0350906 A1
(43) Pub. Date: Nov. 13, 2025

(54) CONTENT GENERATION FOR A VEHICLE

(71) Applicant: International Business Machines Corporation, Armonk, NY (US)

(72) Inventors: Alecio Pedro Delazari Binotto, Munich (DE); Shahrokh DAIJAVAD, Morgan Hill, CA (US); Fernando Luiz Koch, Palm Beach Gardens, FL (US); Gregor Resing, Neu-Ulm (DE); Michele Diserio, Brookline, MA (US); Markus Brandes, Holzgerlingen (DE); Peter Schel, Hamburg (DE)

(21) Appl. No.: 18/747,727

(22) Filed: Jun. 19, 2024

(30) Foreign Application Priority Data
May 8, 2024 (GB) 2406382.8

(51) Int. Cl. H04W 4/029; G01C 21/34; H04W 28/08

(52) U.S. Cl. CPC H04W 4/029; G01C 21/3484; H04W 28/0942

(57) ABSTRACT

Disclosed is a method for serving by a distributed communication system a vehicle traveling from an origin to a destination. The distributed communication system comprises an initial set of computer systems. The method comprises: predicting a route of the vehicle from a current location of the vehicle to the destination. Resource information may be used for selecting from the initial set of computer systems a set of computer systems that can provide machine learning based content to the vehicle along the route. A subset of one or more computer systems of the set of computer systems may be selected for generating a predicted content. A generation of the predicted content may be offloaded to the subset of computer systems. Content delivery computer systems of the initial set of computer systems may be controlled to deliver the generated content to the vehicle in accordance with the specific set of space-time points.

### BACKGROUND

The present invention relates to the field of digital computer systems, and more specifically, to a method for serving by a distributed communication system a vehicle traveling from an origin to a destination.

A radio access network (RAN) may provide access to and coordinate the management of resources across sites of a mobile telecommunication system in accordance with a protocol stack. The radio access network may provide processing resources which may, for example, be used to infer artificial intelligence (AI) models. However, there is a need to improve usage of these AI models.

### SUMMARY

Various embodiments provide a method, computer program product and system as described by the subject matter of the independent claims. Advantageous embodiments are described in the dependent claims. Embodiments of the present invention can be freely combined with each other if they are not mutually exclusive.

In one aspect, the invention relates to a method for serving by a distributed communication system a vehicle traveling from an origin to a destination, the distributed communication system comprising computer systems, referred to as initial set of computer systems, the method comprising: predicting a route of the vehicle from a current location of the vehicle to the destination; using resource information of the initial set of computer systems and the vehicle for selecting from the initial set of computer systems a set of computer systems that can provide machine learning based content to the vehicle along the route; predicting a content that can be requested at the vehicle at a specific set of one or more space-time points along the route; selecting a subset of one or more computer systems of the set of computer systems for generating the predicted content; offloading a generation of the predicted content to the subset of computer systems; controlling content delivery computer systems of the initial set of computer systems to deliver the generated content to the vehicle in accordance with the specific set of space-time points.

In one aspect the invention relates to a computer program product comprising a computer-readable storage medium having computer-readable program code embodied therewith, the computer-readable program code configured to implement the method of the above embodiment.

In one aspect the invention relates to a computer system for a distributed communication system, the distributed communication system comprising computer systems, referred to as initial set of computer systems, for serving a vehicle traveling from an origin to a destination, the computer system being configured for: predicting a route of the vehicle from a current location of the vehicle to the destination; using resource information of the initial set of computer systems and the vehicle for selecting from the initial set of computer systems a set of computer systems that can provide machine learning based content to the vehicle along the route; predicting a content that can be requested at the vehicle at a specific set of one or more space-time points along the route; selecting a subset of one or more computer systems of the set of computer systems for generating the predicted content; offloading a generation of the predicted content to the subset of computer systems; controlling content delivery computer systems of the initial set of computer systems to deliver the generated content to the vehicle in accordance with the specific set of space-time points.

### BRIEF DESCRIPTION OF THE SEVERAL VIEWS OF THE DRAWINGS

These and other objects, features and advantages of the present invention will become apparent from the following detailed description of illustrative embodiments thereof, which is to be read in connection with the accompanying drawings. The various features of the drawings are not to scale as the illustrations are for clarity in facilitating one skilled in the art in understanding the invention in conjunction with the detailed description. In the drawings:

FIG. 1 is a block diagram of a wireless communication system in accordance with an example of the present subject matter.

FIG. 2 is a flowchart of a method for serving by a distributed communication system a vehicle traveling from an origin to a destination in accordance with an example of the present disclosure.

FIG. 3 is a flowchart of a method for serving by a vehicle using multi-access edge computing (MEC) nodes traveling from an origin to a destination in accordance with an example of the present disclosure.

FIG. 4 is a computing environment in accordance with an example of the present subject matter.

FIG. 5 depicts a cloud computing environment according to an embodiment of the present invention.

FIG. 6 depicts abstraction model layers according to an embodiment of the present invention.

### DETAILED DESCRIPTION

The descriptions of the various embodiments of the present invention will be presented for purposes of illustration but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

The present subject matter may optimize on-demand content generation in a vehicle by orchestrating in-route processing to ensure timely delivery for a user driving from a source place to a target place, so that the user may be capable to use the content when arriving or before arriving the target place. The present subject matter may address in-vehicle hardware limitations to ensure prompt content delivery, reducing delays. It may improve the quality of content generated, countering the effects of restricted graphics processing unit (GPU) capacity on nodes during on-demand content creation. It may enhance the relevance of content produced on-demand by improving the inference capabilities of computer systems along the route. It may overcome delivery bottlenecks by increasing network bandwidth on in-route nodes, guaranteeing smooth delivery of on-demand content.

The vehicle may be a motorized transportation device. The vehicle may be configured to communicate wirelessly. The vehicle may be configured to communicate wirelessly with nodes of a wireless communication system in accordance with a specific radio access technology. The radio access technology may, for example, be evolved universal terrestrial radio access (E-UTRA), or 5G new radio (NR) or 6G but it is not limited thereto. In one example, the vehicle may be configured to communicate wirelessly with other vehicles. The vehicle may include a car, truck, bus, drone or other motorized transport that can communicate wirelessly. The distributed communication system may, for example, comprise a wireless communication system.

The vehicle may, for example, be equipped with artificial intelligence (AI) capabilities. For example, the vehicle may comprise an application that may interact with an AI model. The application may, for example, comprise a web browser or an application program interface (API) client to interact with the AI model through a web-based interface of the AI model or API of the AI model. The AI model may, for example, be a large language model (LLM). A user of the vehicle (e.g., a driver or passenger) may instruct, using the application, the AI model guiding it on what kind of content it should generate. For example, the AI model may be used to enhance the driving experience and provide assistance during the route. The AI model may, for example, act as an assistant, answering questions related to the vehicle's features, providing guidance on maintenance issues, or explaining how to use different aspects of the car's technology.

The present subject matter may enable to serve the vehicle in the distributed communication system. The vehicle will travel from an origin to a destination. A route of the vehicle from a current location of the vehicle to the destination may be predicted. The current location may be the origin or a location between the origin and the destination. The route of the vehicle refers to the path the vehicle follows from the current location to the destination. The route of the vehicle may be in a space covered by the distributed communication system. Thus, the vehicle may benefit from enhanced connectivity, reduced latency, and increased data throughput, allowing for improved navigation, safety, and passenger experience.

Resource information of the initial set of computer systems and the vehicle may be provided. The resource information may comprise types of processing resources, usage patterns of the different types of processing resources and performance patterns of the different types of processing resources. The resource information of the initial set of computer systems as well as of the vehicle may be used for selecting from the initial set of computer systems a set of computer systems that can provide machine learning based content to the vehicle along the route. The machine learning based content may be content generated through machine learning. For example, the set of computer systems may have enough processing resources for generating the machine learning based content. The machine learning based content used for selecting the set of computer systems, may be the largest content requestable by a vehicle e.g., as determined by historical experiences or predictions.

The content that can be requested at the vehicle at a specific set of one or more space-time points along the route may be predicted. For example, user preferences of users of the vehicles and/or historical data of the vehicles may be used to predict the types of content that are likely to be requested during the travel. For example, factors such as the predicted duration of travel between computer systems and user preferences may be used to select a content likely to be needed along the route. The route information may also be used to anticipate key points and intervals where content may be requested. For example, it may be predicted that a user of the vehicle may need or may request the content at the specific set space-time points e.g., it could be predicted that a driver heading to a meeting might need a summary of a prior similar meeting. The predicted content is associated with the set of space-time points. The set of space-time points may comprise one space-time point. Alternatively, the set of space-time points may comprise multiple space-time points. Each space-time point of the set of space-time points may be defined by a location and/or a time. The time of the space-time point may be an absolute time point or relative time point or absolute time range or relative time range. The location of the space-time point may be an absolute location or relative location. The location may be a region or a space point. For example, it may be predicted that a user of the vehicle may request in the afternoon a content after traveling at least 20% of the route. In another example, it may be predicted that a user of the vehicle may request a content at 12 PM and so forth.

For example, the content may consist of a set of one or more distinct parts. In one example, each distinct part of the content is predicted to be delivered to the vehicle at a respective different space-time point of the set of space-time points. That is, each part of the content is predicted for a corresponding space-time point of the set of space-time points e.g., the number of space-time points may be equal to the number of parts of the content. In another example, each part of one or more parts of the content may be delivered to the vehicle at more than one space-time point of the set of space-time points e.g., as reminder texts.

A subset of one or more computer systems of the set of computer systems may be selected for generating the predicted content. For example, although the set of computer systems has been chosen for their content generation capabilities, only a specific subset of these systems is capable of producing the anticipated or predicted content at the set of space-time points e.g., because remaining computer systems may be far away from the set of space-time points.

The generation of the predicted content may be offloaded to the subset of computer systems. The offloading may comprise controlling the subset of computer systems to generate the predicted content. If the subset of computer systems comprises one computer system, the predicted content may be entirely generated by that one computer system.

In one first content generation example, the content may be entirely generated by one computer system of the subset of computer systems. In one second content generation example, the distinct parts of the content may be generated respectively by corresponding computer systems of the subset of computer systems. The parts of the content may, for example, be generated following a specific chronological order. For example, the parts, arranged in chronological order, may be assigned to the subset of systems based on their progressively ascending spatial locations along the route. In one third content generation example, the parts of the content may be grouped into two or more groups, wherein the generation of the content may be performed by generating the groups by respective computer systems of the subset of computer systems.

Hence, the selection of the subset of computer systems may be performed based on the content generation method that can be used. Alternatively, the selection of the subset of computer systems may be performed so that it comprises a sufficient number of computer systems that can implement the generation method that requires the highest number of computer systems. In this way, one may not need to know in advance which content generation method is to be used.

Content delivery computer systems of the initial set of computer systems may be controlled to deliver the generated content to the vehicle in accordance with the specific set of space-time points. The content delivery computer systems may be computer systems which are located or aligned with the specific set of space-time points. The “computer system being aligned with a space-time point” may mean that the computer system is positioned in a way that it matches or corresponds directly with the location or coordinate of the space-time point. For example, if the space-time point is defined by a space point or location X, the computer system may be aligned with the space-time point if the distance between the location of the computer system and the location X is smaller than a maximum distance, wherein the maximum distance may, for example, be the farthest distance at which the computer system can deliver data to the vehicle, while the vehicle is along the route.

According to one example, the selection of the subset of computer systems comprises: assigning suitability scores to the initial set of computer systems based on respective resource information. The suitability scores indicate a capability of the initial set of computer systems for content generation for the vehicle along the route. The suitability scores may be used for selecting the set of computer systems. A spatiotemporal map of a travel of the vehicle along the route may be predicted. The subset of the computer systems may be computer systems whose locations align with the spatiotemporal map and that are in combination sufficient to generate the content.

For example, the resource information may comprise information on one or more processing resources. The processing resource may comprise Graphics Processing Unit (GPU), Central Processing Unit (CPU), memory, storage capacity, network bandwidth, or Input/Output (I/O) operations. Each processing resource may be assigned a weight based on its usage. The usage may be real-time usage and/or future usage of the processing resource. The importance of each processing resource may also be factored into the weight assigned to it e.g., a higher weight to CPU and GPU utilization if content generation is resource intensive. The suitability score for a given computer system may be obtained by combining (e.g., summing) the weights of the processing resources of the computer system. For example, the initial set of computer systems may be ranked according to the suitability scores and the first N ordered computer systems may be the set of computer systems. This may prioritize computer systems that align with current and future requirements ensuring that the computer systems may remain suitable as the vehicle progresses.

By evaluating the capabilities of various computer systems through the suitability scores, tasks can be assigned to the most suitable computer system(s), ensuring efficient use of resources and optimized performance. It may also help in evenly distributing the workload among available computer systems, preventing overburdening of a single computer system and thus reducing the risk of performance bottlenecks.

According to one example, the offloading further comprises: controlling the subset of computer systems to perform the generation of the content by: pre-generating the content before the vehicle starts traveling along the route, or partially generating the content before the vehicle starts traveling along the route and completing the generation of the content after the vehicle starts traveling along the route and before reaching the destination, or entirely generating the content after the vehicle starts traveling along the route and before reaching the destination.

For example, each distinct part of the set of distinct parts may be produced by an AI model such as an LLM. For example, an instance of the same LLM may be installed in each computer system of the initial set of computer systems. The set of distinct parts may be generated using LLM instances respectively. The prompt for each instance may be tailored to the specific part of the content that instance is responsible for generating. For example, the subset of computer systems may comprise a number of computer systems smaller than or equal to the number of the distinct parts of the content. This may enable to assign each part to a distinct computer system.

Pre-generating the content may be performed by generating the whole content by one computer system of the subset of computer systems. In this case, the subset of computer systems may advantageously be selected so that it comprises only one computer system. Alternatively, pre-generating the content may be performed by generating the distinct parts of the content by respective computer systems of the subset of computer systems. In this case, the subset of computer systems may advantageously be selected so that it comprises a computer system per part of the content. Alternatively, the parts of the contents may be grouped into two or more groups, wherein pre-generating the content may be performed by generating groups by respective computer systems of the subset of computer systems. In this case, the subset of computer systems may advantageously be selected so that it comprises a computer system per group of the groups.

Partially generating the content may comprise generating a first subset of parts the set of distinct parts before the vehicle starts traveling along the route. Completing the generation of the content after the vehicle starts traveling along the route and before reaching the destination may be performed by generating a second subset of remaining non-generated parts of the set of distinct parts. The generation of the first subset of parts may be performed by using the first content generation example or the second content generation example or the third content generation example. The generation of the second subset of parts may be performed by using the first content generation example or the second content generation example or the third content generation example.

The computer system of the subset of computer systems that is used to generate the whole content or one or more parts of the content may be randomly selected from the subset of computer systems. Alternatively, the computer system that generates the content or one or more parts of the content may be selected based on its location with respect to the route of the vehicle and in accordance with the time at which said generated content/part is to be delivered to the vehicle.

According to one example, the method further comprises: controlling the subset of computer systems to load the pre-generated content or the partially generated content to the content delivery computer systems before the vehicle starts traveling along the route. Loading the content to a given computer system may comprise sending the content to the given computer system using one or more networks. The one or more networks may or may not include a radio access network of the distributed communication system. Loading the content may enable to deliver the content in time with reduced delay compared to the case where the content is loaded while the vehicle is traveling. Controlling the subset of computer systems to load may comprise controlling each computer system of the subset of computer systems that generated the content or part of the content to send that content or part to the content delivery computer system that has a location enabling it to deliver that content or part to the vehicle in the predicted time. This example may optimize delivery based on the vehicle's progress, ensuring timely and seamless content delivery. Locally cached content may be delivered to the vehicle as the vehicle passes each content delivery computer system along the route.

According to one example, the method further comprises: in case the content is generated partially or entirely after the vehicle starts traveling along the route, controlling the content delivery computer systems and the subset of computer systems to communicate generated content in accordance with the space-time points. The one or computer systems of the subset of computer systems that generated the content may send their respective generated parts to the content delivery computer systems.

This example may use an orchestration method that is able to predict inter-system communication and synchronization to facilitate content transfer and real-time coordination. For example, when the vehicle is approaching a content delivery computer system on the route, it may communicate with the subset of computer systems and request the content generated so far. The subset of computer systems may coordinate with said content delivery computer system to ensure that the content is synchronized, and that the handoff is smooth. Alternatively, the content may be delivered to said content delivery computer system before the vehicle approaches said content delivery computer system and in case the vehicle approaches to the content delivery computer system, the content delivery computer system may automatically send the content to the vehicle.

The control of the communication between the content delivery computer systems and the subset of computer systems may use factors such as predicted travel time between computer systems, content generation speed, and real-time conditions for efficient coordination between the computer systems. For example, predictive models may be used to orchestrate the communication and synchronization between the content delivery computer systems and the subset of computer systems.

In one example, rules and/or pre-trained models may be used to verify that the content generation at the subset of computer systems has been successfully completed. The subset of computer systems may be configured to send acknowledgments to confirm the successful handoff/loading of the respective generated content.

According to one example, the method further comprises: selecting from the initial set of computer systems the content delivery computer systems such that their locations align with the specific set of space-time points or align with a spatiotemporal map of a travel of the vehicle along the route.

For example, for each space-time point of the set of space-time points, at least one content delivery computer system that aligns with the space-time point may be selected from the initial set of computer systems. If the space-time point is defined by a given location, the selected content delivery computer system may have a location which is close to the given location, where “close” means that the difference between the two locations is smaller than the maximum distance. The at least one content delivery computer system that aligns with the space-time point may be one content delivery computer system if the content or part of the content that is to be delivered to the vehicle at the space-time point can be generated by the one content delivery computer system. Alternatively, the at least one content delivery computer system that aligns with the space-time point may be more than one content delivery computer system that can (collectively) generate the content or part of the content that is to be delivered to the vehicle at the space-time point.

The spatiotemporal map may, for example, represent a predicted itinerary of the vehicle along the route from the origin to the destination. The spatiotemporal map may, for example, be provided as a vector, wherein each vector element of the vector may be a tuple that includes both the location of the vehicle and the time at which the vehicle may be at that location. The number of elements in the vector may be smaller than a threshold, e.g., every n kilometers (e.g., n=2) may be represented by one element in the vector. For example, for each element of the vector, a content delivery computer system that aligns with the location in the element may be selected from the initial set of computer systems.

The spatiotemporal map may, for example, be predicted using historical data on the vehicle such as historical travel speeds and times of the vehicle, traffic patterns, and road conditions between the origin and the destination.

According to one example, the method further comprises: determining a current location of the vehicle. In response to determining that the vehicle is in proximity of a given computer system of the content delivery computer systems, the given computer system may be controlled to deliver to the vehicle a content that has been generated by or loaded at the given computer system.

According to one example, while the vehicle is traveling the route, the operation of predicting the route may be repeatedly performed. And in each repetition:
if the route changed from the last predicted route, the operations of selection of the set of computer systems, and content prediction may be repeated, and if the predicted content is different from the last predicted content, the operations of selection of the subset of computer systems, offloading and the controlling may be repeated.

This repeated execution of the method may involve a continuous monitoring of the resource information to obtain the performance of the initial set of computer systems during content generation. This example may enable a dynamical adjusting of selection based on predicted future variations of computer system allocation to make intelligent decisions on the fly, ensuring content generation is offloaded to the most suitable computer system at any given moment.

According to one example, while the vehicle is traveling the route the operation of predicting of the content may be repeatedly performed. And in each repetition: if the predicted content is different from the last predicted content, the operations of selection of the subset of computer systems, offloading and the controlling may be repeated. This may enable the method to align with changing user preferences or unexpected events and dynamically adjust the content loading strategy based on real-time conditions and user interactions.

According to one example, the method further comprises: performing a federated learning across the initial set of computer systems for generating a federated learning model. The federated learning model is configured to predict a resource availability and resource usage by each computer system of the initial set of computer systems. The federated learning model may be used for predicting the resource information of the initial set of computer systems.

According to one example, the prediction of the content is performed using at least one of: user preferences of a user of the vehicle, stored data of users of the vehicles and vehicles or conditions of the route.

The conditions of the route may refer to the factors that characterize the state and usability of the route. The factors may, for example, include traffic levels, weather conditions, road surface quality, accidents and incidents and environmental factors such as air quality and noise levels. For each of these factors, a content may be used or required at the vehicle. For example, in the event of an accident, content might be requested to enable the driver to access information near the accident site, as there could be traffic congestion in that area. The user preferences may, for example, include information details about each area the vehicle traverses, meeting summaries of past meetings to which the user attended, and information on the travel conditions along the route. The data of users of the vehicles and vehicles may be stored in a database accessible by the computer system that performs the prediction of the content. The database may comprise detailed information on contents that are requested in the past by drivers and passengers of the vehicles in order to use that content during the travel.

According to one example, the set of computer systems comprises first computer systems and second computer systems, wherein the first computer systems are multi-access edge computing (MEC) nodes (e.g., 5G-MEC nodes or 6G-MEC nodes) and the second computer systems are cloud systems.

The distributed system comprises the first computer systems which are remotely connected to the second computer systems. The first computer system may be a local computer system e.g., accessible to users. The second computer system may not be part of the first computer system. The second computer system is remote from the first computer system. The first computer system may be configured to connect to the second computer system by any form or medium of wireline and/or wireless digital data communication, e.g., a communication network. Examples of communication networks include a local area network (LAN), a radio access network (RAN), a metropolitan area network (MAN), a wide area network (WAN), Worldwide Interoperability for Microwave Access (WIMAX), a wireless local area network (WLAN), all or a portion of the Internet, any other communication system or systems at one or more locations or a combination thereof.

According to one example, each computer system of the content delivery computer systems is associated with a base station of the distributed communication system, wherein the delivery of content to the vehicle by each content delivery computer system comprises using the base station associated with the content delivery computer system for sending radio frequency signals comprising the content to the vehicle.

According to one example, the subset of computer systems comprises one computer system.

According to one example, the subset of computer systems comprises one computer system per point of the space-time points, wherein each computer system of the subset of computer systems is located with respect to the respective space point such that the computer system can generate a content that can be delivered at the respective time point.

According to one example, the content delivery computer systems are the subset of computer systems.

According to one example, the resource information comprises: real-time resource information and predicted resource information. The real-time resource information may be current usage profiles of the resources of the initial set of computer systems and the vehicle. The predicted resource information may be predicted future usage profiles of the resources of the initial set of computer systems and the vehicle. For example, the predicted resource information may comprise future variations in CPU, GPU, memory, and network usage for each computer system of the initial set of computer systems. The predicted resource information may further include factors such as upcoming processing tasks.

The prediction of the route may, for example, be performed using route conditions such as traffic levels, weather conditions, road surface quality, accidents and incidents and environmental factors such as air quality and noise levels. These conditions may influence travel safety, speed, and comfort. The predicted route may be the one that enables the best travel safety, speed, and comfort.

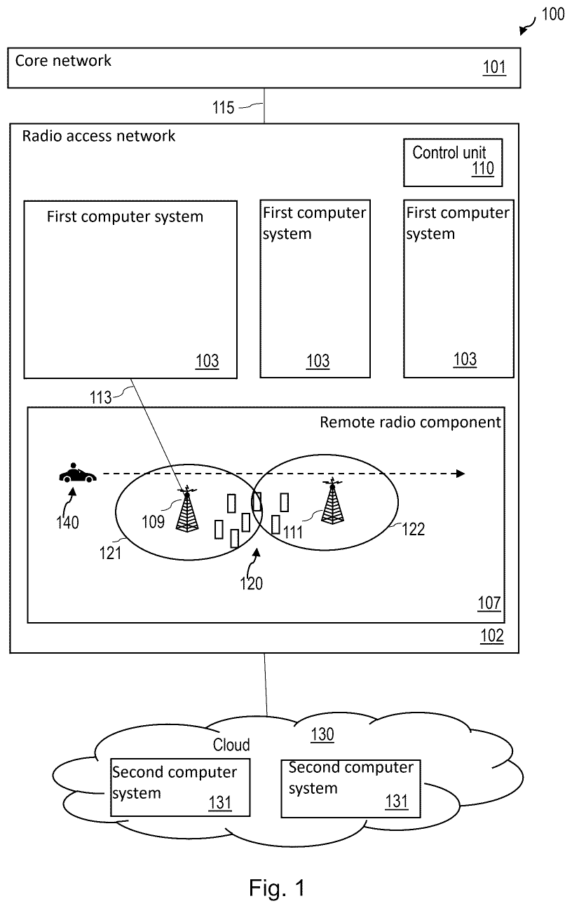

FIG. 1 depicts a diagram of a distributed communication system in accordance with an example of the present subject matter.

The distributed communication system 100 comprises a core network 101 and a radio access network 102. The radio access network 102 may comprise a remote radio component 107 equipped by, but not limited to, base stations 109 and 111. Each base station 109 or 111 may comprise a remote radio unit (RRU) with antennas and may serve vehicles 140 and UEs 120 in respective cells 121 and 122. The radio access network 102 may further comprise first computer systems 103. For simplification of the description only three first computer systems are shown but it is not limited to.

The first computer system 103 may be configured to connect to the core network 101 via a backhaul link 115. Each of the first computer systems 103 may, for example, be provided as a MEC node. The MEC nodes may improve user services (e.g., with a low latency). The first computer system 103 may, for example, process data provided by the respective base station using advanced techniques e.g., for image analysis or content generation. Each first computer system 103 may be connected to a respective base station to provide localized processing and storage capabilities close to mobile users and devices. The connection 113 between the first computer system and the respective base station may enable low-latency and high-bandwidth services that may be required vehicles e.g., autonomous vehicles. For example, the connection 113 may, for example, be a high-speed wired link, such as fiber optic cables.

The radio access network 102 may comprise a control unit 110 for managing workloads in the wireless communication system 100. Although shown as separate component, the control unit 110 may be in another example part of the one or more first computer systems 103.

The remote radio component 107 and the first computer system 103 may be configured to connect, via the radio access network 102, to a cloud computing environment 130. The cloud computing environment 130 may comprise second computer systems 131. For simplification of the description only two second computer systems are shown but it is not limited to. In one example, the second computer system 131 may be provided as a cloud instance in the cloud computing environment 130.

Each computer system of the first computer systems 103 and the second computer systems 131 may for example comprise an AI model such as LLM for content generation.

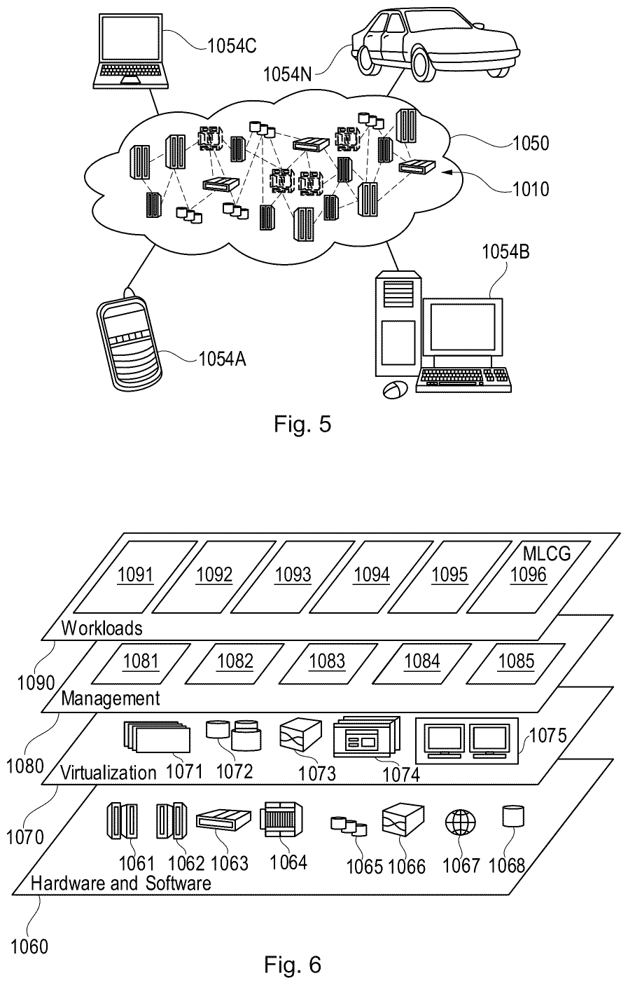

In one example implementation, the cloud computing environment 130 may, for example, be provided as described below with reference to FIGS. 5 and 6. For example, the second computer system 131 may be implemented using one or more functional abstraction layers provided by the cloud computing environment 130 e.g., hardware and software resources of the second computer system 131 may be provided by a hardware and software layer of the cloud computing environment 130. A workload layer of the cloud computing environment 130 may for example be used to implement the creation of the content using the AI model at the second computer system 131.

In one example implementation, the distributed communication system 100 may be provided as an Open Radio Access Network (O-RAN), where the first computer system 103 may be in one or more edge sites and the remote radio component 107 may be in one or more cell sites.

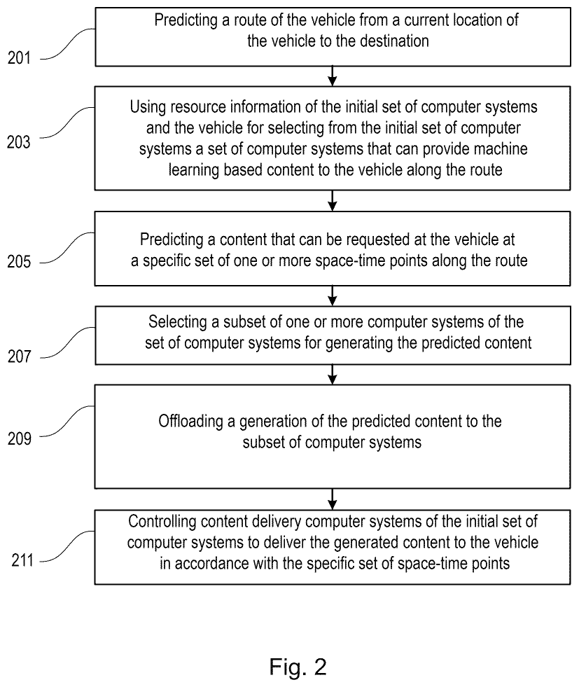

FIG. 2 is a flowchart of a method for serving, by a distributed communication system, a vehicle (e.g., 140 of FIG. 1) traveling from an origin to a destination in accordance with an example of the present disclosure. The distributed communication system comprises an initial set of computer systems. The distributed communication system may, for example, be the wireless communication system 100 of FIG. 1. The initial set of computer systems may, for example, comprise the first computer systems 103. Optionally, the initial set of computer systems may further comprise the second computer systems 131. The method may, for example, be performed by the control unit 110.

In step 201, a route of the vehicle from a current location of the vehicle to the destination may be predicted.

In step 203, resource information of the initial set of computer systems and the vehicle may be used for selecting from the initial set of computer systems a set of computer systems that can provide machine learning based content to the vehicle along the route.

A content that can be requested at the vehicle at a specific set of one or more space-time points along the route may be predicted in step 205.

A subset of one or more computer systems of the set of computer systems may be selected in step 207 for generating the predicted content.

A generation of the predicted content may be offloaded in step 209 to the subset of computer systems.

Content delivery computer systems of the initial set of computer systems may be controlled in step 211 to deliver the generated content to the vehicle in accordance with the specific set of space-time points.

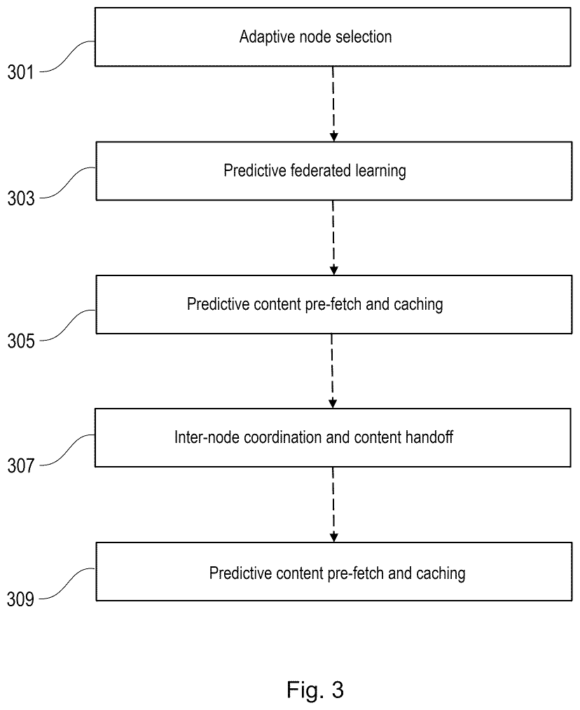

FIG. 3 is a flowchart of a method for serving using MEC nodes a vehicle (e.g., car) traveling from an origin to a destination in accordance with an example of the present disclosure.

In step 301, an adaptive node selection algorithm may be used to assess real-time conditions of 5G-MEC nodes along the route and adapt node selection based on predicted future variations, ensuring intelligent decisions on-the-fly. For example, the following may be performed. Real-time information may be collected about the assessment of 5G/6G-MEC Nodes and in-vehicle hardware from the 5G/6G-MEC Load Management Panel, focusing on historical performance data analysis to identify patterns and trends in node performance and past resource usage during similar content generation tasks. Node selection may be adjusted considering future variations through a model-based approach by applying a fine-tuned model to predict future variations in CPU, GPU, memory, and network usage for each node, taking into account factors such as upcoming tasks, route changes, or anticipated resource fluctuations, and providing a dynamic context representation to the node selection process, which is rule-based. A weighted scoring may be used for node suitability, assigning weightings to different factors based on their importance, such as giving higher weight to CPU and GPU utilization if content generation is resource-intensive, and calculating a suitability score for each 5G-MEC node, considering real-time conditions and predicted future variations. Content offloading decisions may be made for offloading content generation to the selected nodes, using threshold-based selection to filter nodes that meet or exceed the defined thresholds under acceptable conditions. A continuous monitoring may be performed to provide feedback on the performance of the selected nodes during content generation to refine predictions and adapt to changing conditions.

In step 303, a predictive federated learning may be performed to determine the best node for offloading based on global insights and predicted future variations. This may, for example, be performed as follows. For example, given a defined criteria for determining the suitability of a node, one may take into account real-time conditions, predicted time to each region, and user preferences to obtain weighting factors such as current resource availability, historical performance, and anticipated changes. The predicted time sequence T (X) may be predicted using rule-based methods, leveraging historical data to estimate the time it will take to reach each in-route region (X), considering traffic patterns, road conditions, and historical travel times for accurate predictions. The node selection algorithm may be applied, which may also be rule-based, using the defined suitability criteria to prioritize nodes that align with current and future requirements, and dynamically adjusting the node selection based on the predicted time (T (X)) for each region to ensure nodes remain suitable as the car progresses. Distributed federated learning may be implemented by initializing federated learning across the distributed nodes, distributing initial models for resource availability and demand patterns to each node, and conducting federated learning iterations where local models are collaboratively trained using insights from all nodes. A continuous monitor and dynamic adjustment of the node selection may be performed for assessing the performance of selected nodes and real-time conditions during content generation, and ensuring the selected node remains suitable based on the updated global model and real-time conditions as the car progresses on its route.

In step 305, a predictive content pre-fetch and caching may be performed to pre-load a subset of content onto nodes based on predictive analysis of user preferences and route information. For example, user preferences and historical data may be analysed to predict the types of content likely to be requested during the journey, considering the route information to anticipate key points and intervals where content may be requested. For pre-fetching, a subset of content may be selected based on factors like predicted travel duration between nodes and user preferences. One may pre-generate or partially generate this content, ensuring it is ready for instant delivery if pre-generated, or prepare it for on-demand completion if partially generated. In content offloading, one may strategically position a node N* based on the predicted travel path to optimize content offloading and identify node N* for offloading the remaining parts of the content for final generation. Content delivery may be optimized based on the car's progress, ensuring timely and seamless access, and may be performed by delivering locally cached content as the car passes each predefined node along the route. One may continuously monitor and adjust the content delivery success at each node, realigning the subset selection process with changing user preferences or unexpected events, and dynamically adjusting the pre-fetching strategy based on real-time conditions and user interactions.

In step 307, inter-node coordination and content handoff may be performed to ensure seamless content handoff between in-route nodes and distant nodes. Factors like predicted travel time between nodes, content generation speed, and real-time conditions may be used for efficient predictive communication and synchronization orchestration, utilizing predictive models to manage communication and synchronization between nodes along the route and with node N*. One may continuously monitor the car's location in real-time to detect when it is approaching a 5G-MEC node, and apply rules to initiate communication with node N* as the car approaches a specific node on route, sharing information about the content generated so far and the progress of the content generation process. One may coordinate the content handoff with node N* to ensure seamless continuation of the content generation process, sharing relevant data and metadata. A rule-based synchronization mechanism may be implemented to align the content generation processes between the current node and node N*, adjusting content generation speed and resource allocation for a smooth handoff. Rules or pre-trained models may be used to verify the successful completion of content generation at node N* and receive acknowledgment to confirm the successful handoff.

In step 309, predictive content prefetch and prioritization may be performed to prefetch and prioritize content chunks anticipated to be needed soon before reaching a node in-route. Rules and/or pre-trained models may be applied for predictive analysis for content needs to anticipate specific content chunks likely needed soon along the route, considering user preferences, historical data, and upcoming events. Requests may be triggered to the cloud for generating these content chunks before reaching a node on route, and applying prioritization criteria based on predicted content needs and real-time conditions, including the urgency of content, user preferences, and proximity to the next node. One may offload to cloud-based content generation as needed, for generating the requested content chunks based on prioritization criteria, and dynamically allocating resources to meet the content's urgency and priority. The generated content chunks may be prefetched to the vehicle's local storage as it approaches the designated node, optimizing prefetching based on predicted timing and prioritization. The delivery of prefetched content may be prioritized as the car approaches the specified node, ensuring that prioritized content is ready for delivery and reducing reliance on cloud resources for real-time generation. One may dynamically adjust content prioritization based on real-time conditions and the car's proximity to the node, taking into account unexpected changes in user preferences or route information. one may dynamically update the off-loaded content into the in-vehicle stored content, maintaining the relevance and readiness of the content for use.

The present subject matter may comprise the following clauses.

Clause 1. A method for serving by a distributed communication system a vehicle traveling from an origin to a destination, the distributed communication system comprising computer systems, referred to as initial set of computer systems, the method comprising: predicting a route of the vehicle from a current location of the vehicle to the destination; using resource information of the initial set of computer systems and the vehicle for selecting from the initial set of computer systems a set of computer systems that can provide machine learning based content to the vehicle along the route; predicting a content that can be requested at the vehicle at a specific set of one or more space-time points along the route; selecting a subset of one or more computer systems of the set of computer systems for generating the predicted content; offloading a generation of the predicted content to the subset of computer systems; controlling content delivery computer systems of the initial set of computer systems to deliver the generated content to the vehicle in accordance with the specific set of space-time points.

Clause 2. The method of clause 1, the selecting comprising: assigning suitability scores to the initial set of computer systems based on respective resource information, the suitability scores indicating a capability of the initial set of computer systems for content generation for the vehicle along the route; using the suitability scores for selecting the set of computer systems; predicting a spatiotemporal map of a travel of the vehicle along the route; selecting the subset of the computer systems whose locations align with the spatiotemporal map and that is sufficient to generate the content.

Clause 3. The method of any of the preceding clauses 1 to 2, wherein the offloading further comprises: controlling the subset of computer systems to perform the generation by: pre-generate the content before the vehicle starts traveling along the route; or partially generate the content before the vehicle starts traveling along the route and complete the generation of the content after the vehicle starts traveling along the route and before reaching the destination; or entirely generate the content after the vehicle starts traveling along the route and before reaching the destination.

Clause 4. The method of clause 3, further comprising: controlling the subset of computer systems to load the pre-generated content or the partially generated content to the content delivery computer systems before the vehicle starts traveling along the route.

Clause 5. The method of clause 3 or 4, further comprising: in case the content is generated partially or entirely after the vehicle starts traveling along the route, controlling the content delivery computer systems and the subset of computer systems to communicate generated content to meet the set of space-time points.

Clause 6. The method of any of the preceding clauses 1 to 5, further comprising: selecting from the initial set of computer systems the content delivery computer systems whose locations align with the specific space-time points or align with a spatiotemporal map of a travel of the vehicle along the route.

Clause 7. The method of any of the preceding clauses 1 to 6, further comprising: determining a current location of the vehicle; in response to determining that the vehicle is in proximity of a given computer system of the content delivery computer systems, controlling the given computer system to deliver to the vehicle the content that has been generated by or loaded at the given computer system.

Clause 8. The method of any of the preceding clauses 1 to 7, while the vehicle is traveling the route, repeatedly performing the predicting of the route, and in each repetition: if the route changed from a last predicted route, repeating selection of the set of computer systems, and the content prediction, and if the predicted content is different from a last predicted content, repeating the selection of the subset of computer systems, the offloading and the controlling.

Clause 9. The method of any of the preceding clauses 1 to 7, while the vehicle is traveling the route repeatedly performing the predicting of the content, and in each repetition: if the predicted content is different from a last predicted content, repeating the selection of the subset of computer systems, the offloading and the controlling.

Clause 10. The method of any of the preceding clauses 1 to 9, further comprising: performing a federated learning across the initial set of computer systems for generating a federated learning model, the federated learning model being configured to predict a resource availability and resource usage by each computer system of the initial set of computer systems; using the federated learning model for predicting the resource information of the initial set of computer systems.

Clause 11. The method of any of the preceding clauses 1 to 10, wherein the prediction of the content is performed using at least one of: user preferences of a user of the vehicle, stored data of vehicles or users of the vehicles. and conditions of the route.

Clause 12. The method of any of the preceding clauses 1 to 11, the set of computer systems comprising first computer systems and second computer systems, wherein the first computer systems are multi-access edge computing (MEC) nodes and the second computer systems are cloud systems.

Clause 13. The method of any of the preceding clauses 1 to 12, each computer system of the content delivery computer systems is associated with a base station of the distributed communication system, wherein the delivery of content by each content delivery computer system comprises using the base station associated with the content delivery computer system for sending radio frequency signals comprising the content.

Clause 14. The method of any of the preceding clauses 1 to 13, the subset of computer systems comprising one computer system.

Clause 15. The method of any of the preceding clauses 1 to 13, the subset of computer systems comprising one computer system per point of the space-time points, wherein each computer system of the subset of computer systems is located with respect to the respective space point such that the computer system can generate a content that can be delivered at the respective time point.

Clause 16. The method of any of the preceding clauses 1 to 15, the content delivery computer systems being the subset of computer systems.

Clause 17. The method of any of the preceding clauses 1 to 16, the resource information comprising: real-time resource information and predicted resource information.

Clause 18. A computer program product comprising a computer-readable storage medium having computer-readable program code embodied therewith, the computer-readable program code configured to implement a method for serving by a distributed communication system a vehicle traveling from an origin to a destination, the distributed communication system comprising computer systems, referred to as initial set of computer systems, the method comprising: predicting a route of the vehicle from a current location of the vehicle to the destination; using resource information of the initial set of computer systems and the vehicle for selecting from the initial set of computer systems a set of computer systems that can provide machine learning based content to the vehicle along the route; predicting a content that can be requested at the vehicle at a specific set of one or more space-time points along the route; selecting a subset of one or more computer systems of the set of computer systems for generating the predicted content; offloading a generation of the predicted content to the subset of computer systems; controlling content delivery computer systems of the initial set of computer systems to deliver the generated content to the vehicle in accordance with the specific set of space-time points.

Clause 19. A computer system for a distributed communication system, the distributed communication system comprising computer systems, referred to as initial set of computer systems, for serving a vehicle traveling from an origin to a destination, the computer system being configured for: predicting a route of the vehicle from a current location of the vehicle to the destination; using resource information of the initial set of computer systems and the vehicle for selecting from the initial set of computer systems a set of computer systems that can provide machine learning based content to the vehicle along the route; predicting a content that can be requested at the vehicle at a specific set of one or more space-time points along the route; selecting a subset of one or more computer systems of the set of computer systems for generating the predicted content; offloading a generation of the predicted content to the subset of computer systems; controlling content delivery computer systems of the initial set of computer systems to deliver the generated content to the vehicle in accordance with the specific set of space-time points.

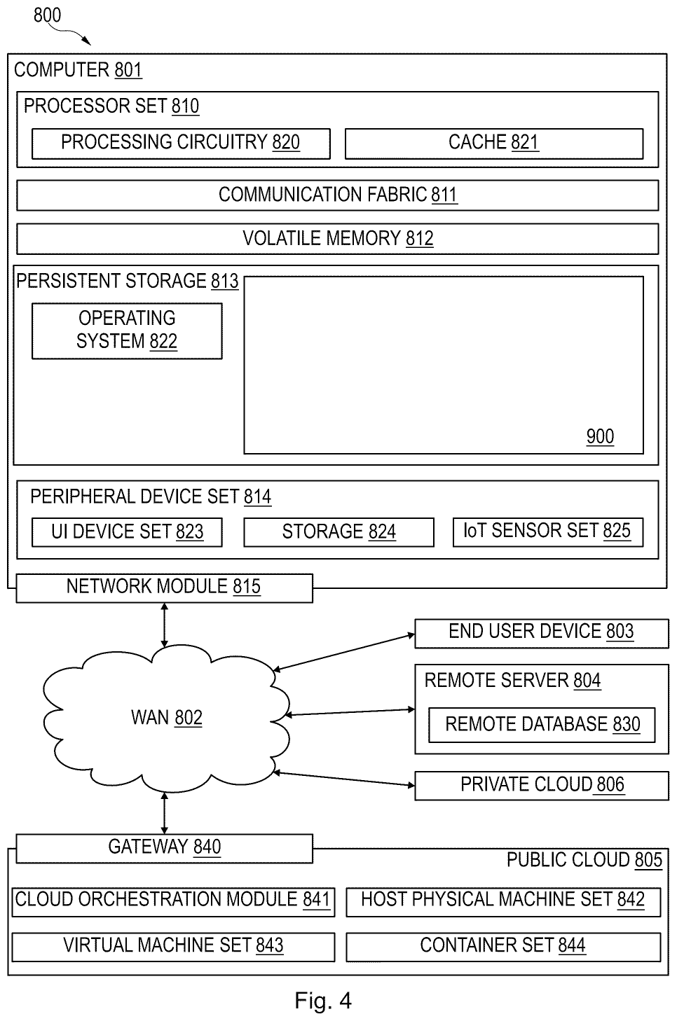

Referring to FIG. 4, an exemplary computing environment 800 is depicted, according to at least one embodiment. Computing environment 800 contains an example of an environment for the execution of at least some of the computer code involved in performing the inventive methods, such as code 900 for serving a vehicle traveling from an origin to a destination. In addition to block 900, computing environment 800 includes, for example, computer 801, wide area network (WAN) 802, end user device (EUD) 803, remote server 804, public cloud 805, and private cloud 806. In this embodiment, computer 801 includes processor set 810 (including processing circuitry 820 and cache 821), communication fabric 811, volatile memory 812, persistent storage 813 (including operating system 822 and block 900, as identified above), peripheral device set 814 (including user interface (UI) device set 823, storage 824, and Internet of Things (IoT) sensor set 825), and network module 815. Remote server 804 includes remote database 830. Public cloud 805 includes gateway 840, cloud orchestration module 841, host physical machine set 842, virtual machine set 843, and container set 844.

COMPUTER 801 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 830. As is well understood in the art of computer technology, and depending upon the technology, performance of a computer-implemented method may be distributed among multiple computers and/or between multiple locations. On the other hand, in this presentation of computing environment 800, detailed discussion is focused on a single computer, specifically computer 801, to keep the presentation as simple as possible. Computer 801 may be located in a cloud, even though it is not shown in a cloud in FIG. 4. On the other hand, computer 801 is not required to be in a cloud except to any extent as may be affirmatively indicated.

PROCESSOR SET 810 includes one, or more, computer processors of any type now known or to be developed in the future. Processing circuitry 820 may be distributed over multiple packages, for example, multiple, coordinated integrated circuit chips. Processing circuitry 820 may implement multiple processor threads and/or multiple processor cores. Cache 821 is memory that is located in the processor chip package(s) and is typically used for data or code that should be available for rapid access by the threads or cores running on processor set 810. Cache memories are typically organized into multiple levels depending upon relative proximity to the processing circuitry. Alternatively, some, or all, of the cache for the processor set may be located “off chip.” In some computing environments, processor set 810 may be designed for working with qubits and performing quantum computing.

Computer readable program instructions are typically loaded onto computer 801 to cause a series of operational steps to be performed by processor set 810 of computer 801 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 821 and the other storage media discussed below. The program instructions, and associated data, are accessed by processor set 810 to control and direct performance of the inventive methods. In computing environment 800, at least some of the instructions for performing the inventive methods may be stored in block 900 in persistent storage 813.

COMMUNICATION FABRIC 811 is the signal conduction path that allows the various components of computer 801 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

VOLATILE MEMORY 812 is any type of volatile memory now known or to be developed in the future. Examples include dynamic type random access memory (RAM) or static type RAM. Typically, volatile memory 812 is characterized by random access, but this is not required unless affirmatively indicated. In computer 801, the volatile memory 812 is located in a single package and is internal to computer 801, but, alternatively or additionally, the volatile memory may be distributed over multiple packages and/or located externally with respect to computer 801.

PERSISTENT STORAGE 813 is any form of non-volatile storage for computers that is now known or to be developed in the future. The non-volatility of this storage means that the stored data is maintained regardless of whether power is being supplied to computer 801 and/or directly to persistent storage 813. Persistent storage 813 may be a read only memory (ROM), but typically at least a portion of the persistent storage allows writing of data, deletion of data and re-writing of data. Some familiar forms of persistent storage include magnetic disks and solid state storage devices. Operating system 822 may take several forms, such as various known proprietary operating systems or open source Portable Operating System Interface-type operating systems that employ a kernel. The code included in block 900 typically includes at least some of the computer code involved in performing the inventive methods.

PERIPHERAL DEVICE SET 814 includes the set of peripheral devices of computer 801. Data communication connections between the peripheral devices and the other components of computer 801 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 823 may include components such as a display screen, speaker, microphone, wearable devices (such as goggles and smart watches), keyboard, mouse, printer, touchpad, game controllers, and haptic devices. Storage 824 is external storage, such as an external hard drive, or insertable storage, such as an SD card. Storage 824 may be persistent and/or volatile. In some embodiments, storage 824 may take the form of a quantum computing storage device for storing data in the form of qubits. In embodiments where computer 801 is required to have a large amount of storage (for example, where computer 801 locally stores and manages a large database) then this storage may be provided by peripheral storage devices designed for storing very large amounts of data, such as a storage area network (SAN) that is shared by multiple, geographically distributed computers. IoT sensor set 825 is made up of sensors that can be used in Internet of Things applications. For example, one sensor may be a thermometer and another sensor may be a motion detector.

NETWORK MODULE 815 is the collection of computer software, hardware, and firmware that allows computer 801 to communicate with other computers through WAN 802. Network module 815 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 815 are performed on the same physical hardware device. In other embodiments (for example, embodiments that utilize software-defined networking (SDN)), the control functions and the forwarding functions of network module 815 are performed on physically separate devices, such that the control functions manage several different network hardware devices. Computer readable program instructions for performing the inventive methods can typically be downloaded to computer 801 from an external computer or external storage device through a network adapter card or network interface included in network module 815.

WAN 802 is any wide area network (for example, the internet) capable of communicating computer data over non-local distances by any technology for communicating computer data, now known or to be developed in the future. In some embodiments, the WAN 802 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 803 is any computer system that is used and controlled by an end user (for example, a customer of an enterprise that operates computer 801), and may take any of the forms discussed above in connection with computer 801. EUD 803 typically receives helpful and useful data from the operations of computer 801. For example, in a hypothetical case where computer 801 is designed to provide a recommendation to an end user, this recommendation would typically be communicated from network module 815 of computer 801 through WAN 802 to EUD 803. In this way, EUD 803 can display, or otherwise present, the recommendation to an end user. In some embodiments, EUD 803 may be a client device, such as thin client, heavy client, mainframe computer, desktop computer and so on.

REMOTE SERVER 804 is any computer system that serves at least some data and/or functionality to computer 801. Remote server 804 may be controlled and used by the same entity that operates computer 801. Remote server 804 represents the machine(s) that collect and store helpful and useful data for use by other computers, such as computer 801. For example, in a hypothetical case where computer 801 is designed and programmed to provide a recommendation based on historical data, then this historical data may be provided to computer 801 from remote database 830 of remote server 804.

PUBLIC CLOUD 805 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 805 is performed by the computer hardware and/or software of cloud orchestration module 841. The computing resources provided by public cloud 805 are typically implemented by virtual computing environments that run on various computers making up the computers of host physical machine set 842, which is the universe of physical computers in and/or available to public cloud 805. The virtual computing environments (VCEs) typically take the form of virtual machines from virtual machine set 843 and/or containers from container set 844. It is understood that these VCEs may be stored as images and may be transferred among and between the various physical machine hosts, either as images or after instantiation of the VCE. Cloud orchestration module 841 manages the transfer and storage of images, deploys new instantiations of VCEs and manages active instantiations of VCE deployments. Gateway 840 is the collection of computer software, hardware, and firmware that allows public cloud 805 to communicate through WAN 802.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 806 is similar to public cloud 805, except that the computing resources are only available for use by a single enterprise. While private cloud 806 is depicted as being in communication with WAN 802, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 805 and private cloud 806 are both part of a larger hybrid cloud.

CLOUD COMPUTING SERVICES AND/OR MICROSERVICES (not separately shown in FIG. 4): private and public clouds are programmed and configured to deliver cloud computing services and/or microservices (unless otherwise indicated, the word “microservices” shall be interpreted as inclusive of larger “services” regardless of size). Cloud services are infrastructure, platforms, or software that are typically hosted by third-party providers and made available to users through the internet. Cloud services facilitate the flow of user data from front-end clients (for example, user-side servers, tablets, desktops, laptops), through the internet, to the provider's systems, and back. In some embodiments, cloud services may be configured and orchestrated according to as “as a service” technology paradigm where something is being presented to an internal or external customer in the form of a cloud computing service. As-a-Service offerings typically provide endpoints with which various customers interface. These endpoints are typically based on a set of APIs. One category of as-a-service offering is Platform as a Service (PaaS), where a service provider provisions, instantiates, runs, and manages a modular bundle of code that customers can use to instantiate a computing platform and one or more applications, without the complexity of building and maintaining the infrastructure typically associated with these things. Another category is Software as a Service (SaaS) where software is centrally hosted and allocated on a subscription basis. SaaS is also known as on-demand software, web-based software, or web-hosted software. Four technological sub-fields involved in cloud services are: deployment, integration, on demand, and virtual private networks.

It is to be understood that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g., networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or data center).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported, providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure that includes a network of interconnected nodes.

Referring now to FIG. 5, illustrative cloud computing environment 1050 is depicted. As shown, cloud computing environment 1050 includes one or more cloud computing nodes 1010 with which local computing devices used by cloud consumers, such as, for example, personal digital assistant (PDA) or cellular telephone 1054A, desktop computer 1054B, laptop computer 1054C, and/or automobile computer system 1054N may communicate. Nodes 1010 may communicate with one another. They may be grouped (not shown) physically or virtually, in one or more networks, such as Private, Community, Public, or Hybrid clouds as described hereinabove, or a combination thereof. This allows cloud computing environment 1050 to offer infrastructure, platforms and/or software as services for which a cloud consumer does not need to maintain resources on a local computing device. It is understood that the types of computing devices 1054A-N shown in FIG. 5 are intended to be illustrative only and that computing nodes 1010 and cloud computing environment 1050 can communicate with any type of computerized device over any type of network and/or network addressable connection (e.g., using a web browser).

Referring now to FIG. 6, a set of functional abstraction layers provided by cloud computing environment 1050 (FIG. 5) is shown. It should be understood in advance that the components, layers, and functions shown in FIG. 6 are intended to be illustrative only and embodiments of the invention are not limited thereto. As depicted, the following layers and corresponding functions are provided:

Hardware and software layer 1060 includes hardware and software components. Examples of hardware components include: mainframes 1061; RISC (Reduced Instruction Set Computer) architecture based servers 1062; servers 1063; blade servers 1064; storage devices 1065; and networks and networking components 1066. In some embodiments, software components include network application server software 1067 and database software 1068.

Virtualization layer 1070 provides an abstraction layer from which the following examples of virtual entities may be provided: virtual servers 1071; virtual storage 1072; virtual networks 1073, including virtual private networks; virtual applications and operating systems 1074; and virtual clients 1075.

In one example, management layer 1080 may provide the functions described below. Resource provisioning 1081 provides dynamic procurement of computing resources and other resources that are utilized to perform tasks within the cloud computing environment. Metering and Pricing 1082 provide cost tracking as resources are utilized within the cloud computing environment, and billing or invoicing for consumption of these resources. In one example, these resources may include application software licenses. Security provides identity verification for cloud consumers and tasks, as well as protection for data and other resources. User portal 1083 provides access to the cloud computing environment for consumers and system administrators. Service level management 1084 provides cloud computing resource allocation and management such that required service levels are met. Service Level Agreement (SLA) planning and fulfillment 1085 provide pre-arrangement for, and procurement of, cloud computing resources for which a future requirement is anticipated in accordance with an SLA.

Workloads layer 1090 provides examples of functionality for which the cloud computing environment may be utilized. Examples of workloads and functions which may be provided from this layer include: mapping and navigation 1091; software development and lifecycle management 1092; virtual classroom education delivery 1093; data analytics processing 1094; transaction processing 1095; and a ML based content generator (MLCG) 1096 that generates content on request in accordance with the present subject matter.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

What is claimed is:

1. A method for serving by a distributed communication system a vehicle traveling from an origin to a destination, the distributed communication system comprising computer systems, referred to as initial set of computer systems, the method comprising:
predicting a route of the vehicle from a current location of the vehicle to the destination;
using resource information of the initial set of computer systems and the vehicle for selecting from the initial set of computer systems a set of computer systems that can provide machine learning based content to the vehicle along the route;
predicting a content that can be requested at the vehicle at a specific set of one or more space-time points along the route;
selecting a subset of one or more computer systems of the set of computer systems for generating the predicted content;
offloading a generation of the predicted content to the subset of computer systems; and
controlling content delivery computer systems of the initial set of computer systems to deliver the generated content to the vehicle in accordance with the specific set of space-time points.

2. The method of claim 1, wherein the selecting further comprises:
assigning suitability scores to the initial set of computer systems based on respective resource information, the suitability scores indicating a capability of the initial set of computer systems for content generation for the vehicle along the route;
using the suitability scores for selecting the set of computer systems;
predicting a spatiotemporal map of a travel of the vehicle along the route; and
selecting the subset of the computer systems whose locations align with the spatiotemporal map and that is sufficient to generate the content.

3. The method of claim 1, wherein the offloading further comprises:
controlling the subset of computer systems to perform the generation by:
pre-generating the content before the vehicle starts traveling along the route; or
partially generating the content before the vehicle starts traveling along the route and complete the generation of the content after the vehicle starts traveling along the route and before reaching the destination; or
entirely generating the content after the vehicle starts traveling along the route and before reaching the destination.

4. The method of claim 3, further comprising:
controlling the subset of computer systems to load the pre-generated content or the partially generated content to the content delivery computer systems before the vehicle starts traveling along the route.

5. The method of claim 3, further comprising:
in case the content is generated partially or entirely after the vehicle starts traveling along the route, controlling the content delivery computer systems and the subset of computer systems to communicate generated content to meet the set of space-time points.

6. The method of claim 1, further comprising:
selecting from the initial set of computer systems the content delivery computer systems whose locations align with the specific space-time points or align with a spatiotemporal map of a travel of the vehicle along the route.

7. The method of claim 1, further comprising:
determining a current location of the vehicle; and
in response to determining that the vehicle is in proximity of a given computer system of the content delivery computer systems, controlling the given computer system to deliver to the vehicle the content that has been generated by or loaded at the given computer system.

8. The method of claim 1, further comprising:
while the vehicle is traveling the route, repeatedly performing the predicting of the route, in each repetition:
if the route changed from a last predicted route, repeating selection of the set of computer systems, and the content prediction; and
if the predicted content is different from a last predicted content, repeating the selection of the subset of computer systems, the offloading, and the controlling.

9. The method of claim 1, further comprising:
while the vehicle is traveling the route, repeatedly performing the predicting of the content, in each repetition:
if the predicted content is different from a last predicted content, repeating the selecting, the offloading and the controlling.

10. The method of claim 1, further comprising:
performing a federated learning across the initial set of computer systems for generating a federated learning model, the federated learning model being configured to predict a resource availability and resource usage by each computer system of the initial set of computer systems; and
using the federated learning model for predicting the resource information of the initial set of computer systems.

11. The method of claim 1, wherein the prediction of the content is performed using at least one of: user preferences of a user of the vehicle, stored data of vehicles or users of the vehicles, and conditions of the route.

12. The method of claim 1, the set of computer systems comprising first computer systems and second computer systems, wherein the first computer systems are multi-access edge computing (MEC) nodes and the second computer systems are cloud systems.

13. The method of claim 1, each computer system of the content delivery computer systems is associated with a base station of the distributed communication system, wherein delivery of content by each content delivery computer system comprises using the base station associated with the content delivery computer system for sending radio frequency signals comprising the content.

14. The method of claim 1, the subset of computer systems comprising one computer system.

15. The method of claim 1, the subset of computer systems comprising one computer system per point of the space-time points, wherein each computer system of the subset of computer systems is located with respect to the respective space point such that the computer system can generate a content that can be delivered at the respective time point.

16. The method of claim 1, the content delivery computer systems being the subset of computer systems.

17. The method of claim 1, the resource information comprising real-time resource information and predicted resource information.

18. A computer program product, the computer program product comprising:
one or more computer-readable tangible storage medium and program instructions stored on at least one of the one or more tangible storage medium, the program instructions executable by a processor capable of performing a method for serving by a distributed communication system a vehicle traveling from an origin to a destination, the distributed communication system comprising computer systems, referred to as initial set of computer systems, the method comprising:
predicting a route of the vehicle from a current location of the vehicle to the destination;
using resource information of the initial set of computer systems and the vehicle for selecting from the initial set of computer systems a set of computer systems that can provide machine learning based content to the vehicle along the route;
predicting a content that can be requested at the vehicle at a specific set of one or more space-time points along the route;
selecting a subset of one or more computer systems of the set of computer systems for generating the predicted content;
offloading a generation of the predicted content to the subset of computer systems; and
controlling content delivery computer systems of the initial set of computer systems to deliver the generated content to the vehicle in accordance with the specific set of space-time points.

19. A computer system for a distributed communication system, the distributed communication system comprising computer systems, referred to as initial set of computer systems, for serving a vehicle traveling from an origin to a destination, the computer system comprising:
one or more processors, one or more computer-readable memories, one or more computer-readable tangible storage medium, and program instructions stored on at least one of the one or more tangible storage medium for execution by at least one of the one or more processors via at least one of the one or more memories, wherein the computer system is capable of performing a method comprising:
predicting a route of the vehicle from a current location of the vehicle to the destination;
using resource information of the initial set of computer systems and the vehicle for selecting from the initial set of computer systems a set of computer systems that can provide machine learning based content to the vehicle along the route;
predicting a content that can be requested at the vehicle at a specific set of one or more space-time points along the route;
selecting a subset of one or more computer systems of the set of computer systems for generating the predicted content;
offloading a generation of the predicted content to the subset of computer systems; and
controlling content delivery computer systems of the initial set of computer systems to deliver the generated content to the vehicle in accordance with the specific set of space-time points.
